(19) United States
(12) Patent Application Publication
(10) Pub. No.: US 2010/0233662 A1
(43) Pub. Date: Sep. 16, 2010

(54) METHOD FOR TREATING AUTISM SPECTRUM DISORDERS

(75) Inventor: Maureen Casper, Rye, NY (US)

Correspondence Address: Kevin McMahon, 191 Marshall Ridge Road, New Canaan, CT, 06840, US

(73) Assignee: THE SPEECH INSTITUTE, LLC, Rye, NY (US)

(21) Appl. No.: 12/402,340

(22) Filed: Mar. 11, 2009

(51) Int. Cl. G09B 19/04

(52) U.S. Cl. 434/185

(57) ABSTRACT

A therapeutic method for developing the ability of subjects with autism spectrum disorders to produce and perceive spoken language, including sequentially modeling a set of words, the speaking of which involves making a first and a second articulatory gesture, as pictures corresponding to such words are displayed, in order to induce the subject to attempt to say the modeled words, until the subject is able to produce the constrictions of the oral-pharyngeal cavity associated with both of said articulatory gestures of the words together with vibration of the vocal folds, and the subject is able to produce such words intelligibly. The subject's ability is incrementally expanded using sets of words involving the making of other articulatory gestures until the subject is able to intelligibly produce words involving substantially all of the articulatory gestures used in the language of interest. Positive visual reinforcement is given to the subject for each word that the subject is able to produce intelligibly. For subjects having a level of intelligibility, the ability to produce generative speech is developed, first by displaying a set of pictures depicting actions corresponding to verbs, the speaking of which involves making a first articulatory gesture and modeling or phonetically facilitating the verb corresponding to each of said pictures until the subject is able to produce the verbs. Positive feedback is provided to the subject each time the subject says verb corresponding to one of said displayed pictures by animating said picture to produce the action corresponding to the verb. The subject's ability is expanded using sets of verbs involving the making of other articulatory gestures and further expanded using phrases containing such verbs with the display of corresponding pictures. In the next stage of the method the subject's ability to produce generative language is further expanded with the use of stories. The subject's progress is monitored by uploading and analyzing data including speech samples.

This invention relates to methods for treating autism spectrum disorders in children by improving their speech perception and production ability.

### BACKGROUND OF INVENTION

Autism spectrum disorders (ASD) are neurodevelopmental disorders along a continuum of severity that are generally characterized by marked deficits in social and communicative functioning. The number of children with ASD is an emerging public health crisis, with the Centers for Disease Control and Prevention reporting that 1 in 150 children who were born in 2007 are affected, which is an increase of 172% in diagnoses over the past decade.

ASD includes autism, Asperger syndrome, and pervasive developmental disorder not otherwise specified (usually referred to as PDD-NOS). ASD is characterized by impaired social interaction, problems with verbal and nonverbal communication, and unusual, repetitive, or severely limited activities and interests. For example, an affected child may focus exclusively on spinning the wheels of a toy car or on the way one part of the car feels or smells, as opposed to playing with it as intended, and often will react to change or interruption by acting out or withdrawing. Some children with ASD are abnormally sensitive to sound, touch, or other sensory stimulation.

Children with ASD also exhibit significant delays in the development of communication in both nonverbal and verbal communicative behavior. Nonverbal deficits can include reduced amounts of manual gestures such as the use of pointing to direct a person's attention and pre-linguistic vocalization such as babbling and early vocal play.

Many children diagnosed with ASD never develop functional language skills. Even those who develop the ability to communicate verbally begin to speak later and at a significant slower rate than typical children. Children with ASD who develop spoken language typically have a severely restricted ability to initiate and to maintain a conversation, and commonly have stereotyped or idiosyncratic speech patterns. These can include speech and voice characteristics, such as uninflected and robot-like or sing-song or echolalic speech. Stereotyped speech refers to a highly repetitive, highly specific language that is often centered on inappropriate and arbitrary topics. The failure to develop the ability to produce novel utterances (generative language) and the inability to produce normal intonational patterns or to understand conversational speech are primary deficits present in children with ASD.

The profiles of behaviors and deficits for children with various forms of ASD vary from one individual to another, and even for a given individual may change as the child develops.

A number of treatment regimes are in use for children with ASD, with varying degrees of benefit. The current most widely accepted treatments are based on the applied behavior analysis (ABA) methods, which are systems of behavioral training based on the work of B. F. Skinner that have been adapted for ASD. These methods involve the individualized treatment of the symptoms of ASD by a system of antecedent, behavior, consequence. For example, the attending provider may prompt the child to sit (the antecedent), and if the child does so (the behavior), he or she is rewarded e.g., by giving the child something he or she likes (the consequence). If the child does not perform the requested behavior, the reward is withheld. It is expected or hoped that when the antecedent is repeated that be child will repeat the behavior with the expectation of receiving a reward. Thus, these methods basically seek to alter the child's behavior through external reinforcement.

Other current treatment regimes for ASD include Floortime, in which the parent engages the child socially at a level the child currently enjoys, enters the child's activities, and follows the child's lead. From a mutually shared engagement, the parent is instructed how to move the child toward more increasingly complex interactions, a process known as opening and closing circles of communication. Floortime does not separate and focus on speech, motor, or cognitive skills but rather addresses these areas through a synthesized emphasis on emotional development. The intervention is called Floortime because the parent gets down on the floor with the child to engage him or her at the child's level.

As a neuro-physiological disorder, ASD is expressed in both a loss of limb movement and speech. Several therapies are often provided, including occupational and physical therapy and speech therapy. Occupational therapy methods seek, both at home and within the school setting, to improve the fine and gross motor skills of a child with ASD by teaching activities including dressing, toilet training, grooming, buttoning, fine motor and visual skills that assist in writing and scissor use, gross motor coordination to help the individual ride a bike or walk properly, and visual perceptual skills needed for reading and writing.

These and a number of other current treatment techniques for autism are described in the websites of the following organizations: the Autism Society of America, the National Institute of Mental Health, and Autism Speaks.

The ability to perceive and produce sounds of speech is essential to early language development. A disruption in this neuro-developmental ability results in an array of problematic behaviors as children fail to adapt to the increased demands of their world. Thus, problems in the processing of speech sounds create significant deficits in language and social functioning throughout development. Speech is a tool that allows children to adapt to the increasing complexity of their world as they grow and develop. For example, when a child starts to walk, their world becomes more complex, and an inability to communicate verbally can become an increasingly frustrating problem.

### SUMMARY OF THE INVENTION

In accordance with the present invention there is provided a therapeutic method for developing the production and perception of spoken language in subjects with ASD by enabling the subject to perform the neurologically controlled, rapid coordinated movements of the articulators, i.e., the lips, tongue, jaw, soft palate and the vocal folds (also referred to as vocal cords), and the shaping of the oral-pharyngeal cavity during vocalization that produce the sounds of speech. It is believed that the method of the invention works to develop the neurological pathways of the child's brain and speech motor control, i.e., the ability to perform the physiological events, or articulatory gestures, that produce the patterns of sound that form speech. An articulatory gesture involves temporally coordinated movement occurring at the syllabic level that includes movement of articulators to produce a constriction in the oral-pharyngeal cavity combined with vocal fold vibration and shaping of the oral-pharyngeal cavity. An important aspect of the method is the use of systematic and controlled auditory and visual stimuli to incrementally increase the range and complexity of the utterances that the child is capable of producing and perceiving.

In accordance with a first aspect of the invention, there is provided a therapeutic method for developing the ability of an subject with ASD to produce and perceive spoken language, comprising the steps of displaying pictures corresponding to a set of words, the speaking of each of which involves making a given first articulatory gesture that the subject is able to produce and a given second articulatory gesture; modeling a word of the set as the corresponding picture is displayed in order to induce the subject to attempt to say the modeled word, until the subject is able to produce both of the articulatory gestures of such word and to speak the word intelligibly; giving the subject visual positive reinforcement when the subject successful performs the activity; and sequentially repeating the above steps for the other words of the set until the subject is able to produce all of the words of the set intelligibly. The first and second articulatory gestures can be the same or different gestures. Preferably, the corresponding word is displayed in association with each of said pictures.

In accordance with another aspect of the invention, the therapeutic method includes the steps of displaying pictures corresponding to a second set of words, the speaking of each of which involves making such first articulatory gesture, and a different articulatory gesture, individually modeling the words of the second set as the corresponding picture is displayed in order to induce the subject to attempt to say the modeled word until the subject is able to perform both of such articulatory gestures for the words of the second set, repeating the above steps until the subject is able to speak the words of second set intelligibly. The subject is given visual positive reinforcement for the successful performance of a specified activity for a word.

In accordance with another aspect of the invention, a therapeutic method for improving the production and perception of spoken language of a subject with ASD, comprising the steps of displaying pictures depicting actions corresponding to verbs, the speaking of which involves making a first articulatory gesture; modeling or phonetically facilitating the verb corresponding to each of said pictures one or more times until the subject says the verb being modeled or phonetically facilitated; providing positive feedback to the subject each time the subject says the modeled or phonetically facilitated verb corresponding to one of said displayed pictures by animating said picture to produce the action corresponding to the verb; and repeating the above steps using pictures corresponding to other verbs, the speaking of which involves making articulatory gestures different from said selected articulatory gesture.

In accordance with another aspect of the invention, A therapeutic method for improving the production and perception of spoken language of a subject with ASD, comprising the steps of displaying a set of pictures depicting actions corresponding to verbs, the speaking of which involves making an articulatory gesture, and a phrase describing the action in association with each picture, said phrase including the corresponding verb; selecting one of the pictures; displaying, in conjunction with the selected picture, a second picture, different from said selected picture, depicting an action corresponding to the same verb as the selected picture, and a second phrase describing the action depicted in the second picture, the second phrase also including such verb; modeling the phrase corresponding to the selected picture one or more times until the subject says the phrase being modeled; modeling the phrase corresponding to the second picture one or more times until the subject says the phrase being modeled; providing positive feedback to the subject each time the subject says the modeled phrase by animating the corresponding picture to produce the action corresponding to the verb; and repeating the above steps using pictures of such set depicting an action corresponding to another verb, the speaking of which involves making an articulatory gesture different from the articulatory gesture involved in saying said selected verb.

In accordance with another aspect of the invention, the therapeutic method of the invention includes sequentially displaying pages of text and associated pictures of a story while the words of the text are modeled as they are displayed, thereafter sequentially displaying the pages of text and associated pictures of the story and modeling the text of each page as the corresponding page is displayed and pausing after modeling each page to encourage the subject to your read the text of such page aloud, thereafter sequentially displaying the pages of text and associated pictures of the story without modeling such text, pausing for each page to allow the subject to read the text on such page aloud, and modeling the text on each page after the subject has read the text aloud. The therapeutic method further includes thereafter sequentially displaying the pages of text and associated pictures of the story without modeling the text, pausing for each page to allow the subject to read the text on such page aloud, recording the subject's voice as the subject reads such text aloud, and playing back the subject's voice reading the text to the subject. The text is selected to emphasize words involving the making of one or more selected articulatory gestures.

In accordance with another aspect of the invention, the attending provider uploads data concerning the activities during an intervention session and results thereof to a server, and periodic reports concerning the progress of the subject are generated.

### DETAILED DESCRIPTION

In accordance with the invention, it is believed that a fundamental characteristic of autism spectrum disorders ASD, especially of autism and Asperger syndrome, is a neurophysiological sensory motor disorder that has a profound impact on the perception and production of spoken language. Spoken language is produced by coordinated movement that is physiologically and neurologically driven. While not wishing to be bound by a particular scientific explanation, it is believed that autism affects the neurological pathways of the brain such that the ability of the child to perceive and interpret sounds as spoken language, as distinguished from other non-speech-like sounds of the environment, is impaired. The method of the present invention builds the child's neurophysiological competence in the production of intelligible and flexible speech and facilitates the perception of spoken language. For most individuals, the sounds of speech are processed in the left hemisphere of the brain. They are distinctly human and involve neurologically controlled, rapid, coordinated movements of the articulators and shapings of the oral cavity, and vibrations of the vocal folds.

As a typical young child moves through early years of development, both limb and speech emerge in complimentary course. Typical children roll over, sit, reach, point, walk, and babble. The sounds of early babbling eventually become increasingly more intelligible until the child begins to label and then combine words. As children adapt to the increasing demands of their language environment they produce increasing more complex speech utterances. Increased competence in speech production allows typical children to exercise control over their environment through speech.

Speech is the tool that allows children to learn and to interact with others. Through speech they organize and convey their thoughts, label their world, and express their emotions. In the earliest stages of development, children with ASD usually have similar problem solving and relationship recognition abilities as typical children. It is not until speech is expected in early childhood development that the first signs of ASD become evident.

Speech is neurologically and physiologically driven movement that becomes patterns of sound. Deficits in neurological control of coordinated movement of both articulators and limbs are the hallmarks of autism spectrum disorders. In the method of the invention, ASD is treated as a disruption in motor control that affects both speech and limb behaviors.

Many children with ASD have deficits in their ability to understand spoken language. Some children diagnosed with ASD can produce intelligible speech, but use language in inappropriate ways, or have problems adjusting speech patterns. The inability to communicate through speech impairs their ability to exercise control over their environment through speech, and causes children with ASD to become increasingly frustrated and confused. Often, they attempt to interact with their environments by engaging in inappropriate or stereotypical behaviors, or withdraw into themselves.

Normal speech is highly variable in that the words are made up of periodic components (e.g., roughly speaking, the vowel sounds in “baby” and “mommy”) and noise components (e.g., roughly speaking, the consonant sounds in “catch”) that are temporally interspersed at various lengths, intensities and frequencies, and vary from speaker to speaker and for an individual speaker in different situations. Typical children respond playfully to songs and rhymes as they develop the sounds of speech, while children with ASD may respond to many songs and rhymes, but frequently not to conversational speech. It is believed that this is the case because the sounds of songs and rhymes to which children with ASD are able to respond are characterized acoustically by lengthened periodicity and repeatable patterns and de-emphasize the rapid transitions present in conversational speech. The periodic components of speech are produced by vibration of vocal folds and modified by the shaping of the oral-pharyngeal cavity, while the noise components result from the constriction of articulators within the oral-pharyngeal cavity. The speech signal is characterized by rapid transitions between periodic and noise components. In order for a child to be able to produce and perceive spoken language, it is essential the child has the ability to process such rapid transitions. This perceptual ability is disrupted in the brain of a child with ASD.

An important aspect of the method of the invention is the developing of the neural pathways of a child with ASD to be able to process the sounds of speech, i.e. to be able to produce and to understand spoken language. This includes developing the child's speech motor control i.e., the ability to perform the physiological events, or articulatory gestures, that produce the patterns of sound that form speech. The method of the invention recognizes that the ability to produce speech is fundamental to the perception of spoken language. In other words, speech production drives speech perception—if the child is not able to produce spoken language, it also impairs the child's ability to perceive the sounds of speech as spoken language.

Another important aspect of the method of the invention is that it improves a child subject's ability to process variability in sound input such as exists in human speech. This is preferably done by initially training the subject with controlled, e.g., recorded speech, starting with single words and then incrementally and systematically increasing the length and variability of the utterances as the subject is able to produce and perceive targeted words, phrases and sentences, e.g. “walking,” “boy walking,” “dog walking,” “girl walking to the store.”

The treatment in accordance with the illustrated embodiment of the invention of a child with ASD notionally includes activities of diagnosis, intervention, and monitoring. These activities are not necessarily temporally separated from one another, but may overlap in time, and are typically iterative, in that there often are sessions of diagnosis during intervention as the child progresses, and monitoring activities occur throughout the course of the intervention. Additionally, some of the same or similar tools and procedures may be used for more than one activity, e.g., for diagnosis and for monitoring, or for diagnosis and for intervention.

The method normally begins with a diagnostic phase to assess the child's cognitive ability and to provide a neuro-linguistic profile in order to gain an understanding of the characteristics of the individual's disorder and level of language ability. This is useful both to determine the starting level at which to begin the intervention and to provide a baseline for measuring future progress. For a severely affected child whose ability to produce any intelligible speech at all is severely limited or nonexistent, it may be necessary to begin with an intervention phase in order to bring the child's ability to produce language up to a level that the cognitive ability and neuro-linguistic profile can be assessed.

In contrast with other current methods for treating a child subject with ASD, the method of the present invention does not assess the subject's condition in terms of the severity of his or her inappropriate behaviors. Rather, the assessment is based on the subject's ability to produce and to perceive speech. Based on this assessment, children with ASD can be grouped roughly into four categories. The first category includes children who are unable to produce any speech, or even to babble, and are unable to echo the words or sounds that they hear. These children can be suffering both from autism and verbal apraxia. It has been found that, in most cases, the method of the invention has only limited application for children accurately diagnosed with verbal apraxia. It has also been found, however, that some children with ASD who have been diagnosed with apraxia because they are nonverbal, are actually not apraxic, and can experience substantial benefits from intervention using the method of the invention.

The second category includes children who have the ability to produce at least a few babble-like syllables or words or are echolalic to some degree, i.e., they will imitate words or in phrases that they hear, either immediately or at some later time. The assessment is not concerned with the meaning of what the child can say, but only with the physiological articulatory gestures used to produce the sounds that a child can say.

The third category includes children who have the ability to produce substantially the full range of motions involved in articulatory gestures and are typically echolalic. The fourth category includes the more highly functioning children with ASD. These children can produce intelligible speech and can imitate entire sentences that they hear. Sometimes, they may memorize entire passages from a favorite book and, when prompted by some (perhaps seemingly unrelated) stimulus, may recite the entire passage (referred to as “scripting”). Their ability to use language in a meaningful, communicative way is impaired, however. The rhythm and intonation of their speech is atypical (e.g., sounds like robotic speech), and they may experience sound, word, and structural confusion (e.g., saying “black” when meaning “back”).

In accordance with the method of the invention, the intervention activities for autistic children for which the method is appropriate (including those grouped in categories two through four, and some in group one) focus on improving their ability to produce and perceive intelligible and flexible speech. The method involves continually incrementally and systematically increasing the variety and complexity of the auditory stimuli presented to the child with the objective of developing the child's competence in speech perception and generative production.

In accordance with the illustrated embodiment of the invention, the articulatory gestures used in the English language are grouped roughly into six classes according to the target constriction resulting from movement of articulators within the oral-pharyngeal cavity. These classes are: lip closure, tongue fronting, tongue elevation, tongue backing, dental labial, and dental lingual. Each class is organized by a muscular activity and cranial nerve innervation involved in the dynamic movement of articulators for the relevant constriction. This allows for similar speech sounds to be grouped by motor function (as opposed to phonemically or phonologically) so that several different, but physiologically related, sounds may be practiced together in a class. The lip closure class includes all syllables/words that involve VII cranial nerve innervation of the obicularis oris muscle for activation of the lips (e.g., “baby,” “mommy,” “puppy” and “woman”). The tongue fronting class includes all syllables/words involving the genioglossus and superior longitudinal muscles and their XII cranial nerve innervations, which the moves the tongue to the alveolar ridge (e.g., “daddy,” “tunnel,” “sitting and “noodle”). The tongue backing class includes all syllables/words involving the styloglossus and palatoglossus muscles, respectively backing and raising the tongue to the soft palate, and their respective XII and the XI cranial nerve innervations (e.g. “kicking,” “cookie” and “goggles”). The tongue elevation class includes all syllables/words involving the inferior longitudinal muscle and XII cranial nerve innervations, which moves the tongue to the hard palate (e.g. “giraffe,” “cherry” and “yo yo”). The labial dental class includes all syllables/words involving the inferior obicularis oris muscle and VII cranial nerve innervations, which moves the lower lip into contact with the upper central incisors (e.g., “fever” and “fluffy”). The lingual dental class includes those syllables/words involving the superior longitudinal muscle and VII cranial nerve innervations, which moves the tip of the tongue into contact with the upper incisors (e.g., “thy,” “thigh” and the first syllable of “thermos”). Each constriction results in noise or a combination of noise and periodicity of the sound signal.

In addition to the constriction, each articulatory gesture also includes a periodic component in a timed relationship with the constriction. The production of these periodic components (or vowel sounds) involves vibration of the vocal folds and shaping of the oral-pharyngeal cavity. The three more pronounced shapings of the oral-pharyngeal cavity, referred to as the three point vowels, are those associated with:
lip-rounding, such as used in producing the “oo” sound in “spoon”
lip spreading, such as used in producing the “ee” sound in “keep”
jaw descension, such as used in producing the “o” sound in “pop”

Other vowel sounds are more neutral and are produced with less pronounced shapings of the oral-pharyngeal cavity.

The relative timing between the release of the constriction (noise) and the onset of vocal fold vibration (periodicity), referred to as voice onset time, provides the mechanism by which speakers produce and listeners discern certain speech sounds. This coordinated behavior is exemplified by the physiological differences in the production of “beep” vs. “peep,” “teep” vs. “deep” and “keep” vs. “geep.”

It has been found that children with ASD have less difficulty saying words having two coordinated articulatory gestures, i.e. two syllable words, than one syllable words. The two syllable words of the English language are produced (or can be closely approximated) using 36 sets of coordinated pairs of articulatory gestures. These include the following six sets of two coordinated repeating articulatory gestures:
lip closure-lip closure e.g., “baby,” “puppy”
tongue fronting-tongue fronting e.g., “noodle,” “sitting”
tongue elevation-tongue elevation e.g., “giraffe,” “yo-yo”
tongue backing-tongue backing e.g., “cookie,” “cracker”
dental labial-dental labial e.g., “fluffy,” “fever”
dental lingual-dental lingual e.g., “the thing”

Coordinated articulatory gestures used in two syllable words also include the approximately 30 alternating coordinated articulatory gestures that are made up of all of the combinations of two different articulatory gestures, e.g., lip closure-tongue fronting (e.g., “bunny,” “puzzle”), and lip closure-tongue elevation (e.g., “walrus,” “wheelchair”). Words containing more syllables are produced using coordinated combinations of the six classes of articulatory gestures.

The speaking of other languages may involve the making of all or most of the coordinated articulatory gestures used in English plus additional articulatory gestures, e.g. in Italian, the articulatory gesture used in producing the sound for “gli” appearing in a word is not used in English. The method of the invention is applicable to children of any language. The description of the illustrated embodiment is given in terms of the English language for ease of description.

During the diagnostic phase, the spoken language ability of a child with ASD may be analyzed for perceptual strengths and weaknesses by the presentation of various lengths and complexities of the speech signal, and the production of speech as it may vary for labeling, producing sounds which code the developmental morphology of spoken utterances, the ability to repeat sentences of increasing length and complexity. All combined, these tasks, when analyzed with neuro-physiological and neuro-linguistic principles, provide a measure of short and long term memory function, imitation skills, verbal recall, word finding, and a standard, quantitative measure of language development. The initial diagnosis phase includes focusing on assessing the child's speech related abilities in the following areas:
The ability to produce speech-like sounds, which may range from babbling to words.
The range of articulatory gestures that the child is able to make.
The range of repeating and alternating coordinated articulatory gestures that the child is able to make.
The child's ability to comprehend and produce language as single words, phrases, and sentences.
The child's overall linguistic development, including vocabulary and understanding of the structure and use of language.

The assessments with regard to the first three items on the above list are normally performed by the attending provider by assessing the sounds that the child is able to produce, typically in response to verbal or pictorial stimuli or both, and, also usefully, by questioning the child's parents, teachers and attending providers of other therapies concerning the sounds or words that the child is able to say. The neuro-linguistic profile can also include an assessment of the child's ability to perceive recorded speech vs. live human speech, of the child's single word vocabulary using pictures to assess the child's ability to imitate the name of, or point to, the object shown in a picture when the name is modeled (i.e., spoken aloud), and of the intelligibility of the child's speech based on the ability to produce coordinated articulatory gestures.

There are various diagnostic techniques that can be used to assist in assessing a child's cognitive ability and neuro-linguistic profile in accordance with the illustrated embodiment of the invention, particularly with regard to the fourth item on the above list. These include the Peabody Picture Vocabulary Test (PPVT) IIIA or IIIB (Dunn and Dunn) that provides a measure of single word receptive or hearing vocabulary. This is a psycholinguistic measure correlated to other psychological measures of intelligence, and it is statistically supported for the screening of intellectual functioning and predicting academic achievement. Other tests that are useful in assessing the child's single word attending behavior include the Basic Concepts of Clinical Evaluation of Language Function (CELF-Pre-School) test, and the Vocabulary Subtest 1 of the Test of Auditory Comprehension of Language (TACL). Tests that are useful in assessing the child's phrase and sentence attending behavior include TACL Subtests 2 and 3, Preschool CELF Sentence Structure subtests and the Oral and Written Language Skills (OWLS) test. Tests that are useful in assessing the fifth item on the above list include CELF, PPVT and TACL.

In contrast to mental retardation, where sub-average cognitive ability is present in all areas, the neuro-linguistic diagnostic results for a child with ASD is typically characterized by scatter, with the child being able to function well in some areas on appropriate standardized tests, but not in others.

The intervention in accordance with the method of the illustrated embodiment of the invention is preferably performed with the aid of a computer program that is organized in a set of five activities that may be engaged in during intervention sessions. The first activity, Attending, is used, only if necessary, for the purpose of causing the child to pay attention to what is happening on the computer screen. In this activity, the program causes the screen to successively cycle through displaying a number of animated pictures, preferably for about 5 seconds each with a blank screen for about 1 second between each picture. The pictures depict various activities, such as an elephant walking, a boy jumping and a plane flying. Each picture is preferably accompanied by a person's voice, preferably a woman's, modeling the name of the action (e.g., “walking,” “flying”) and sound effects corresponding to the depicted action. Once the child is paying attention to the screen, the attending provider stops the cycling of the pictures and selects one of four intervention activities—Intelligibility, Verbs, Phrases, or Stories.

### Intelligibility

The Intelligibility activity of the intervention for children with ASD in the second category and suitable children in the first category described above in accordance with the illustrative embodiment of the invention includes the goal of enabling the child to produce words that, together, incorporate the full set of coordinated articulatory gestures used in the target language. The intervention preferably begins by building upon the articulatory gestures that the child subject is already able to make by modeling words of a subset containing a pair of such coordinated articulatory gestures and encouraging the subject to say them.

The Intelligibility activity preferably works with two syllable words. The words are preferably grouped into six sets based on the articulatory gesture involved with the first syllable, i.e., lip closure, tongue fronting, tongue backing, or tongue elevation, dental labial, and dental lingual. Each of the six sets can be broken down into six subsets determined by the articulatory gesture involved with the second syllable of the words. There are preferably at least five words in each subset containing words involving the use of the same pair of two different articulatory gestures, and 10 words in each subset containing words involving the use of the same pair of two repeating articulatory gestures. Thus, one subset may contain words all involving the lip closure-tongue fronting coordinated alternating articulatory gestures, such as “bunny,” “puzzle” and “pizza,” while another subset may contain words all involving the tongue backing-tongue backing coordinated articulatory gestures, such as “cougar,” “cookie” and “goggles.”

There is a picture associated with each word. In the illustrative embodiment of Intelligibility Activity, the attending provider first selects a set and subset of words involving a desired pair of coordinated articulatory gestures, which causes the group of pictures corresponding to the words in that subset to be displayed on the computer screen. The attending provider can elect to have the displayed pictures successively highlighted accompanied by a person's voice modeling the corresponding words, in a manner similar to the Attending activity. This is particularly useful the first few times the child has seen the subset of pictures in order to help the child become familiar and comfortable with the pictures and words of the subset.

It is preferable to practice words containing a particular pair of coordinated articulatory gestures repeatedly in order that more words with that pair of coordinated articulatory gestures may be readily spoken with improved intelligibility before moving on to words containing other pairs of coordinated articulatory gestures. For instance, if the subject is able to make the babble sounds “baba”, the intervention may begin with practicing a word from the subset of words having the lip closure-lip closure repeated coordinated articulatory gestures, such as “baby” and extending the practice to the other words contained within that physiological movement group set, e.g.: “baby,” “bubble,” “puppy” and “mopping” while the corresponding pictures are displayed on the screen. Alternatively, hardcopy pictures may be used while the corresponding words are being practiced.

In the initial phase of the Intelligibility activity, e.g., using the lip closure-lip closure subset of words, depending on the subject's initial level of capability the subject may be stimulated to produce words in this grouping regardless of intelligibility. For this set of words, the speech task is to perform the appropriate coordinated articulatory gestures by closing the lips twice and shaping the oral cavity appropriately for the vowel sounds with vocalization. The task is repeated with preferably about 10 different words within the articulatory gesture movement group to develop the subject's ability to produce the general movement pattern of constriction, shaping of the oral cavity and vibration at the vocal folds associated with the relevant articulatory gestures. The subject is preferably given positive visual reinforcement each time he or she successfully performs the speech task for a word. This may be accomplished, for instance, by the attending provider causing the picture associated with the word to flash on the screen when the subject is successful in performing the speech task.

Once the subject demonstrates the capability of producing these movement patterns for all of the words of the group, the next speech task is to practice with the same or a different set of words having the same group of coordinated articulatory gestures until the subject is able to produce all of the words of the set intelligibly. Again, each time the subject successfully performs the speech task for a word he or she is preferably given positive reinforcement, e.g., by the attending provider causing the corresponding picture to flash.

In the Intelligibility activity, it is preferred to begin with subsets of words having a pair of the repeating articulatory gestures, such as lip closure-lip closure. It is further preferable, before going to subsets of words containing alternating coordinated articulatory gestures, to work with subsets of words having pairs of repeating lip closure, tongue backing and tongue fronting gestures. The tongue elevation gesture is typically more difficult and the subsets of words involving the tongue elevation and dental articulatory gestures can be delayed until later in the Intelligibility activity. Thereafter, the same procedure is preferably followed in working with subsets of words containing alternating coordinated articulatory gestures. The first speech task is to produce the relevant movement pattern of constriction, shaping of the oral cavity and vibration at the vocal folds with the subset of words containing the same pair of alternating coordinated articulatory gestures. When the subject is able to complete this task successfully for the subset of words, the next task is to produce such words intelligibly. Depending upon the subject's ability and rate of progress, it may be possible to combine the practice of the two speech tasks for some or all of the subsets of words into one involving both the performance of the two coordinated articulatory gestures and the production of the words with adequate intelligibility.

Especially at the earlier stages of intervention, it is important to carefully select and control the audio stimuli that the subject receives. It is preferable that the subject wear headphones and that the modeled word be a recording. The headphones reduce the ambient noise, and the use of a recording for a modeled word eliminates physiological variability of human voice and controls the signal so that it is exactly the same each time it is modeled. Alternatively, if the subject is not willing to accept the headphones, the modeled word is preferably produced by playing a recording of the word through a speaker. Or the attending provider can model a word by saying it. In any case, it is preferred that the intervention take place in a quiet environment that is free to the extent practicable of distractions such as ambient noises and the activities of other persons.

In the initial phase of the Intelligibility activity, where the speech task is the performance of the articulatory gestures and the shaping of the oral cavity during the vocalization, without regard for intelligibility, it may be preferable for the attending provider to model the words in order to provide visual emphasis of the shaping of the oral cavity and visible aspects of the articulatory gestures for the subject. For instance, if the subject has difficulty saying the second syllable of “baby”, the attending provider may demonstrate and emphasize the lip spreading movement of the mouth in forming the second syllable. The subject is encouraged to say the word “baby” until he or she is able to perform the required speech task properly, or at least to approximate it adequately. The adequacy of the approximation can be a judgment call by the attending provider. This judgment call can be checked and confirmed by the monitoring and feedback function to be described below.

The modeling of the word preferably focuses on the tonal quality of the word by extending the vowel sound; in the case of “baby” by extending the “a” and “y” vowel sounds to some degree, but not so much as to be unnatural. This emphasis on the tonal quality of the speech signal makes it more available to a subject with ASD. For a subject whose attention is not drawn to a displayed image at the particular stage of the intervention, the modeling can be done without the use of a corresponding picture.

At this stage of the intervention, the development of vocabulary, while beneficial, is not the goal of early modeling for articulatory gestures. Rather, the primary goal is to develop the subject's ability to produce the full set of 36 coordinated articulatory gestures. The displaying of a picture corresponding to the modeled word does have the advantage, however, that the subject learns to attach the sounds of modeled words to pictorial representations of those words (referred to as labeling or semantic mapping). It is also preferable that the text of the relevant word be displayed in conjunction with each picture.

When practicing a given word of a subset, the attending provider preferably selectively highlights or enlarges the corresponding picture, for instance by placing the cursor on it, which preferably also causes the computer to model the corresponding word. If the subject does not perform the speech task corresponding to the selected picture when the computer or attending provider models it, the attending provider can repeat or cause the computer to repeat the word, e.g., by single clicking on the picture. In either case, when the attending provider decides that the subject has performed the speech task adequately for a word, the attending provider can cause the corresponding picture to flash a few times, e.g., by double-clicking on the picture, thereby giving the subject visual feedback and reinforcement.

It is important that the environment be controlled during intervention sessions with a minimum of distractive stimuli, and that the variability of the modeled word be minimized. The reason that it is preferable to use recorded speech is because human speech is variable from instance to instance, even if the attending provider is trying to say the word in the same manner each time. It is further preferable, in some cases, that the recorded speech be that of a child of a similar age to that of the subject. It is sometimes beneficial for the recorded speech to be that of someone who is familiar to the subject, such as the mother. It is also very beneficial to record and play back examples of the subject's own speech when he or she is able to say a word or phrase intelligibly. Children with ASD typically will pay close attention to a recording of their own speech, and this procedure is quite helpful in regaining the subject's attention if it starts to wander, and in improving the subject's speech production capability.

It has been found that the above-described procedure of incremental, controlled expansion of the range of articulatory gestures that the subject is able to perform is effective to build the subject's ability to process speech containing noise signals in addition to periodic signals and to improve the subject's ability to process speech containing rapid transitions between periodic and noise signals. When the subject is able to produce words containing substantially all of the 36 sets of coordinated articulatory gestures, he or she is in the transition range between the second and third category.

For articulatory gestures that the subject is not able to perform initially, the practice preferably involves using words containing a combination of an articulatory gesture that the subject is able to produce with one that he or she has not yet been able to perform. For example, if the subject is able to produce words containing repeated lip closure coordinated articulatory gestures, but not ones involving tongue-fronting, the practice may begin with words in the lip closure-lip closure subset, and later be extended to words in the lip closure-tongue fronting alternating subset, such as “bunny” and “puzzle.” By this means, the subject's competence in producing speech at the single word level is incrementally expanded by introducing a new articulatory gesture using words containing such articulatory gesture in combination with an articulatory gesture which the subject is already able to produce, until he or she is able to say words containing all 36 of the sets of coordinated articulatory gestures.

### Verbs

In accordance with an important aspect of the method of the invention, at least by the time that the subject is in or near the transition region between the second and third categories, and frequently earlier in the intervention, the intervention includes or even focuses on the production of speech consisting of or containing verbs, referred to as the Verbs activity. It has been found that working with speech containing verbs, particularly verbs that encode motion or activity, is very effective in improving the spoken language perception and production capability of a subject with ASD, and is an important step towards the ability to produce generative speech.

The Verbs activity of the illustrative embodiment of the intervention normally begins with displaying a picture depicting the action referred to by the verb, e.g., for “running” displaying a still picture of a boy running, and modeling of the verb, in this case “running.” The verbs used are preferably monosyllabic, such as jump, run, bounce, catch, etc. and are used in the present progressive tense, i.e., jumping, running, bouncing, catching, etc., so that the words being practiced have two syllables. The subject preferably wears a headset microphone in order to minimize the distractions from ambient noise and to record the subject's speech. Children with ASD in this developmental category are typically echolalic to some degree and will tend to repeat the verb when they hear it being modeled. If the subject does not say the verb within several seconds, the attending provider can cause it to be modeled again. The modeling is preferably done using a recorded verb in order to eliminate variability between instances of the modeling.

Verbs can be introduced fairly early in the intervention. For example, if the subject can say “baby” or “bubble” and “tickle” intelligibly, the subject has a sufficient range of motion: lip closure, tongue fronting and tongue backing, as well as vocalization to begin working with verbs. Thus, with as few as three intelligible words, the subject is able to begin repeating verbs. Once the subject has a set of about 10 verbs, the attending provider preferably focuses on increasing the intelligibility and number of words containing each set of coordinated articulatory gestures that the subject is able to produce.

The Verbs activity phase of the intervention is also preferably performed with the aid of a computer program. In the illustrative embodiment of the invention, the Verbs activity program includes 32 verbs that are displayed, each with a picture corresponding to the activity denoted by the verb. The verbs and corresponding pictures are preferably displayed in two sets, each displaying a set of 16 verbs and pictures in a 4×4 matrix. The attending provider can select either one of the two sets of pictures for display on the screen. After the attending provider selects one of the two sets, the attending provider can select a row of pictures, for instance by clicking on a button displayed to the left of the row. Preferably, the selected row of pictures with the corresponding words is enlarged and the only the selected row is displayed. Also, preferably, three buttons labeled, e.g., “Cycle,” “Stimulate” and “Feedback” are displayed in association with the displayed row.

In the illustrative embodiment, the system is structured such that, when the attending provider clicks on the Cycle button, the pictures on the row are successively highlighted, the words are modeled by the computer using a woman's voice, and the picture is actuated to perform a motion and play a sound effect corresponding to the verb. When the attending provider clicks on the Stimulate button in the illustrative embodiment, the system enters a mode in which, when the attending provider places the cursor on a selected picture in the row, the picture is highlighted, the corresponding word is modeled using a woman's voice and the picture is actuated. When the attending provider clicks on the Feedback button in the illustrative embodiment, the system enters a mode in which, when the attending provider places the cursor on a selected picture, the picture is highlighted and the word is modeled using a woman's voice. In the illustrative embodiment of both the Stimulate and the Feedback modes, when the attending provider clicks once on the selected picture the word is modeled again, and if the attending provider double-clicks on a selected picture, the picture is actuated and a corresponding sound effect is played. The attending provider can return to the set of 16 pictures, for instance by clicking once on a “back” button, or to a screen for selecting the other of the two sets of 16 pictures by double-clicking on the “back” button. There can also be another mode of operation for use with somewhat more advanced autistic subjects, in which, instead of modeling the entire verb, only the sound of the initial articulatory gesture involved with the verb is modeled, e.g., the “bru” sound for the verb “brushing.” This is referred to as “phonetic facilitation.”

When the subject says the verb or phrase, the attending provider preferably animates the picture, so that, in response to having said the verb “running,” the subject sees the animated picture of the boy running. It is an important feature of the method of the present invention that subject is able to exercise control over the animation (in the Verbs activity) or flashing (in the Intelligibility activity) of the picture displayed on the screen by saying the appropriate verb or word, respectively. In other words, the subject is able to exercise control over his or her environment through speech, and only through speech. This ability to exercise control over the subject's environment through speech in all of the activities of the method of the invention is a powerful reward and reinforcing mechanism, and stands in sharp contrast to other intervention methods for ASD in which the subject is rewarded with something he or she wants, sometimes a cookie or a piece of candy, for performing a requested behavior, such as sitting down in a chair or pointing to a red block, in response to a demand.

The above exercise is repeated with other verbs until that subject is able to say a substantial number of verbs involving different auditory gestures with adequate intelligibility, preferably at least approximately 20 verbs. The verbs are preferably selected such that the initial ones contain auditory gestures with which the subject is most comfortable, and arranged in order of auditory gestures of increasingly difficulty for the subject. When the subject is able to say a verb intelligibly, it is preferable to practice the verb using phonetic facilitation or forced choice instead of modeling. Forced choice involves asking the child to choose between two stimuli, e.g., “Do you want walking or talking?” Again, if the subject says the correct verb intelligibly, the attending provider animates the picture, thereby giving the subject reinforcement by demonstrating that his speech has an effect on his environment and that he can control events through speech.

In a third stage of working with verbs in the illustrative embodiment, the subject is simultaneously presented with two pictures, without sound or animation, each representing a different verb action. The attending provider presents a subject with a choice by saying words to the effect of, “Do you want walking or kicking?” If the subject asks for one of the verbs, the responses reinforced by animating the corresponding picture and by playing the recorded verb, e.g., “kicking.” This exercise is repeated with different pairs of verbs.

### Phrases

When, in the judgment of the attending provider, the subject has achieved an adequate facility in saying the verbs used in the Verbs activity, e.g., if the subject is able to recognize or point to a picture corresponding to the action of the modeled verb among pictures depicting different actions, and spontaneously says the verb when a corresponding picture is presented without auditory input, the attending provider should preferably begin to elicit longer utterances. This can be done, e.g., by modeling phrases such as: “cow jumping” or “boy walking” or “brushing teeth” while displaying pictures corresponding to the activities, preferably with the text of the phrase also displayed in visual association with the relevant picture.

In the illustrative embodiment of the invention, essentially the same two sets of 16 pictures can be used in the Phrase activity as in the Verbs activity, except that, instead of having the verb appearing under each picture, a phrase appears. When the attending provider clicks on one of the pictures of the 4×4 matrix (e.g., a picture showing a baby crying), the 4×4 matrix is replaced by two pictures corresponding to “crying” displayed side-by-side on the screen, one the original picture of the baby crying and the other, e.g., of a boy crying, with the phrases “Baby crying” and “Boy crying” appearing under the corresponding pictures. When the attending provider places the cursor on one of the pictures, the picture is highlighted and the phrase is modeled using a child's voice. If the attending provider clicks once on the picture the phrase is modeled again. If the attending provider double clicks on the picture, the picture actuates. The attending provider can return to the display of the 4×4 matrix, e.g., by clicking on a “back” button displayed on the screen.

At a first level of the Phrases activity in the illustrative embodiment, the displayed phrases consist of the subject and the verb, e.g., “Boy baking.” At a second, more advanced level of the Phrases activity, the displayed phrases are progressively, incrementally increased by adding various subjects and objects (e.g., “boy walking,” “girl walking,” “elephant walking,” “boy bouncing ball,” “girl climbing tree”). Each phrase is modeled and, if the subject repeats it intelligibly, the corresponding picture is animated by the attending provider. As the subject progresses, the attending provider preferably begins to use phonetic facilitation rather than modeling the phrase.

Once the subject has demonstrated some competence at the above level, the length and complexity of the utterances are further increased, again using pictures. E.g., sentences such as “the dog is running,” “the dog is sitting,” “the dog is wagging its tail,” are modeled while a corresponding picture and, preferably, text is displayed, and when the subject repeats the appropriate sentence intelligibly, the picture is animated by the attending provider. The complexity of the utterances can also be increased by introducing longer words having more than two syllables. Also, phonetic facilitation may be used in lieu of modeling.

### Stories

It has also been found in accordance with the invention that having a subject with ASD read stories aloud from books it is quite effective in increasing the subject's ability to produce and perceive spoken language. The pages of the book preferably each contain a picture and successive portions of a related story, which portions may range from a single word or phrase to a paragraph. The books can either be hardcopy versions or a software version in which the pages are displayed sequentially on a computer display. The software version of the books can be stored on the computer or supplied over a network such as the Internet.

The text in the books is preferably arranged to exercise the subject's ability to produce words containing selected coordinated articulatory gestures so that, e.g., one book, or portion of a book may contain text on successive pages emphasizing the use of the lip closure-tongue fronting coordinated articulatory gestures, while another book or portion of the book may contain text on multiple successive pages emphasizing the use of the lip closure-tongue elevation coordinated articulatory gestures. A book may also be used to expand the range of words that the subject is able to produce intelligibly, such as longer words requiring the making of more than two articulatory gestures, or words requiring the making of combinations of coordinated articulatory gestures for which the subject has demonstrated ability to produce the some, but not all of the gestures in combination. Other parts of speech, such as prepositions, adjectives, adverbs and pronouns are introduced incrementally in the stories to build the child's language competence. Another important feature of the method of the invention is that developing the ability of a subject with ASD to produce and perceive longer, more complex utterances in the Phrases and Stories activities, which utterances incorporate rules of the language (e.g., how to form plurals, the appropriate use of prepositions such as “over” versus “under,” the use of pronouns, the ordering of words in a sentence, etc.) greatly improves the ability of a child with ASD to produce and perceive more generative, conversational spoken language.

The Stories activity of the intervention in accordance with the method of the invention is preferably carried out in a sequence of four stages. In the first stage, referred to as Listen-Listen, the entire story is read to the subject, either by being read by the attending provider or, preferably, by being modeled using a recorded voice, while the pages of the book are successively displayed on a computer screen. During the second stage, referred to as Listen-Speak, portions of the text of the book, the length of the portion being determined by the number of syllables that the subject is able to produce, are modeled to the subject sequentially and the subject is prompted after each page is modeled to read the page aloud. The number of syllables in the portions are gradually increased as the subject is able to produce them. In the third stage, referred to as Speak-Listen, the subject reads each page aloud and, after each page is read, the text on the page is modeled either by the attending provider or using a recorded voice. In the fourth stage, referred to as Speak-Recorded, the subject's voice is recorded as he or she reads aloud, and is played back after each page.

### Monitoring and Feedback

In accordance with an important feature of the illustrative embodiment of the invention, periodically, preferably at the end of each intervention session with a subject, the attending provider uploads to a server data concerning the identity of the subject, the date of the intervention session and the nature and results of the activities practiced during the intervention session. The uploaded data preferably include quantitative data for analysis such as the degree of intelligibility, the length of utterance, the morphological complexity, a rating of motor control and the mode of stimulus presentation. For example, for the Intelligibility activity, the data may include the subsets of words being practiced, whether the practice was in the first or second phase, and numerical ratings of the degree of success that was achieved. For instance, if the intervention session worked on the first phase of the Intelligibility activity for the lip closure-lip closure set of words, these numerical ratings may include data on whether the subject was able to produce the constrictions for each of the relevant first and second articulatory gestures for the words of the set. For the second phase of the Intelligibility activity, the data may include whether the subject was able to produce the first and second relevant articulatory gestures including both the constrictions and the shapings of the oral pharyngeal cavity for the words of the set to say the words intelligibly.

For any of the activities, the numerical data may include data such as a rating of motor control, and whether the subject produced words intelligibly, responded to words being modeled or phonetically facilitated, produced utterances without prior verbal stimulation, and on the degree that the subject was able to produce utterances with normal intonational patterns.

Periodically, recorded samples of the subject's speech are preferably also uploaded to the server for acoustical analyses.

The uploaded data and acoustic analyses of the speech samples provide objective data on the progress being made by the subject in the course of the intervention in accordance with the invention. The data and analyses can also be used to isolate problems that may be inhibiting the subject's progress so that feedback and recommendations for specific emphasis can be given to the attending provider in order to maximize the benefit of the intervention to the subject.

While the method of the invention has been described in terms of its applications for children with ASD, the Intelligibility activity may also have important benefits for many subjects with intelligibility deficits, resulting from causes other than ASD, for example, traumatic brain injury, cerebral vascular accidents, developmental aphasias or other developmental deficits.

What is claimed is:

1. A therapeutic method for developing the ability of an subject with ASD to produce and perceive spoken language, comprising the steps of:
a. displaying pictures corresponding to a set of words, the speaking of each of which involves making a given first articulatory gesture that the subject is able to produce and a given second articulatory gesture;
b. modeling a word of said set as the corresponding picture is displayed in order to induce the subject to attempt to say the modeled word, until the subject is able to produce both of the articulatory gestures of such word and to speak the word intelligibly;
c. giving the subject visual positive reinforcement when the subject successfully performs the activity specified in step b; and
d. sequentially repeating steps b and c for the other words of the set until the subject is able to produce all of the words of the set intelligibly.

2. The therapeutic method of claim 1 wherein step b includes the steps of:
a. modeling the word as the corresponding picture is displayed in order to induce the subject to attempt to say the modeled word, until the subject is able to produce the constrictions of the oral-pharyngeal cavity associated with both of said articulatory gestures of the word together with vibration of the vocal folds;
b. giving the subject visual positive reinforcement each time the subject successfully performs the activity specified in step a of claim 2;
c. repeating steps a and b of claim 2 until the subject is able to produce both of the articulatory gestures for the word so that the subject is able to speak the word intelligibly.

3. The therapeutic method of claim 1 wherein the modeling of the word is performed by an attending provider and such provider gives added prominence to shaping of the oral pharyngeal cavity in modeling the vowel sounds of the word.

4. The therapeutic method of claim 1 wherein said visual positive reinforcement includes a change in the display the picture corresponding to said word.

5. The therapeutic method of claim 1 wherein said first and second articulatory gestures are the same gesture.

6. The therapeutic method of claim 1 further including the steps of uploading data concerning the performance by the subject of the activity of step b when the method of claim 1 is performed with a subject; and generating periodic reports of the progress of the subject's ability to perform such activity.

7. The therapeutic method of claim 1 further including the steps of:
a. displaying pictures corresponding to a second set of words, the speaking of each of which involves making said first articulatory gesture and a third articulatory gesture different from said first and second articulatory gestures;
b. individually modeling or phonetically facilitating the words of said second set as the corresponding picture is displayed in order to induce the subject to attempt to say the modeled word, until the subject is able to perform both of said articulatory gestures for the words of said second set and to speak the words of said second set intelligibly, and
c. giving visual positive reinforcement each time the subject successful performs the activity specified in step b of claim 7 for a word.

8. A therapeutic method for developing the ability of a subject having an intelligibility deficit to produce words, the speaking of which requires the making of at least two articulatory gestures, for enabling the subject to produce words that together require the making of a set of articulatory gestures used in a language of interest, comprising the steps of:
a. sequentially displaying pictures corresponding to words requiring the making of an articulatory gesture that the subject is able to produce and a second articulatory gesture, while modeling or providing phonetic facilitation of the words as the corresponding pictures are displayed, to induce the subject to attempt to perform said articulatory gestures and thereby produce said words intelligibly;
b. repeating step a until the subject is able to say said words intelligibility; and
c. repeating steps a and b with words requiring the making of other articulatory gestures until subject is able to produce words requiring the making of all of the articulatory gestures of the set intelligibily.

9. The method of claim 8 wherein said set of articulatory gestures includes substantially all of the articulatory gestures used in the language of interest.

10. A therapeutic method for improving the production and perception of spoken language of a subject with ASD, comprising the steps of:
a. displaying pictures depicting actions corresponding to verbs, the speaking of which involves making a first articulatory gesture;
b. modeling or phonetically facilitating the verb corresponding to each of said pictures one or more times until the subject says the verb being modeled or phonetically facilitated;
c. providing positive feedback to the subject each time the subject says the modeled or phonetically facilitated verb corresponding to one of said displayed pictures by animating said picture to produce the action corresponding to the verb; and
d. repeating steps a, b and c using pictures corresponding to other verbs, the speaking of which involves making articulatory gestures different from said selected articulatory gesture.

11. The therapeutic method of claim 10 further including the steps of uploading data concerning the performance by the subject of the activity of step b when the method of claim 10 is performed with a subject; and generating periodic reports of the progress of the subject's ability to perform such activity.

12. The method of claim 10 wherein a phrase including the verb corresponding to each picture is displayed in association with such picture and wherein step b includes modeling the phrase including said the verb until the subject says such phrase, and wherein the positive feedback of step c is given when the subject says such modeled phrase.

13. A therapeutic method for improving the production and perception of spoken language of a subject with ASD, comprising the steps of:
a. displaying a set of pictures depicting actions corresponding to verbs, the speaking of which involves making an articulatory gesture, and a phrase describing the action in association with each picture, said phrase including the corresponding verb;
b. selecting one of the pictures;
c. displaying, in conjunction with said selected picture, a second picture, different from said selected picture, depicting an action corresponding to the same verb as said selected picture, and a second phrase describing the action depicted in said second picture, said second phrase including said verb;
d. modeling or phonetically facilitating the phrase corresponding to the selected picture one or more times until the subject says the phrase being modeled;
e. modeling or phonetically facilitating the phrase corresponding to said second picture one or more times until the subject says the phrase being modeled;
f. providing positive feedback to the subject each time the subject says the modeled phrase by animating the corresponding picture to produce the action corresponding to the verb; and
g. repeating steps b through f using pictures of said set depicting actions corresponding to another verb, the speaking of which involves making an articulatory gesture different from the articulatory gesture involved in saying said selected verb.

14. A therapeutic method for improving the ability of a subject with ASD to produce and perceive spoken language, comprising the steps of:
a. determining the articulatory gestures of a set of articulatory gestures that the subject is able to produce;
b. having the subject practice producing a group of words the speaking of which involves making an articulatory gesture that the subject is able to produce;
c. incrementally expanding the suite of articulatory gestures that the subject is able to produce by having the subject practice producing another group of words containing an articulatory gesture that the subject is able to produce and another articulatory gesture that the subject has not yet been able to produce until the subject is able to produce the words of said other group; and
d. repeating step c using additional groups of words until the subject is able to produce words that together involve making all of the articulatory gestures of said set; and
e. providing positive visual feedback to the subject each time the subject is successful in producing a word in steps b, c and d intelligibly.

15. The method of claim 14 further including the steps of:
a. sequentially displaying pictures depicting actions corresponding to selected verbs, the speaking of which involves making an articulatory gesture of said set of articulatory gestures, the verbs in total involving the making of all of the articulatory gestures of said set;
b. modeling or phonetically facilitating the verb corresponding to each of said pictures one or more times until the subject says the verb; and
c. providing positive feedback to the subject each time the subject says the verb being modeled or phonetically facilitated.

16. A therapeutic method for improving the speech of a subject with ASD, comprising the steps of:
a. sequentially displaying pages of text and associated pictures of a story while the words of the text are modeled as they are displayed;
b. thereafter sequentially displaying the pages of text and associated pictures of said story and modeling the text of each page as the corresponding page is displayed and pausing after modeling each page to encourage the subject to read the text of such page aloud;
c. thereafter sequentially displaying the pages of text and associated pictures of said story without modeling such text, pausing for each page to allow the subject to read the text on such page aloud, and modeling the text on each page after the subject has read such text aloud.

17. The therapeutic method of claim 16 further including the step of thereafter sequentially displaying the pages of text and associated pictures of said story without modeling said text, pausing for each page to allow the subject to read the text on such page aloud, recording the subject's voice as the subject reads such text aloud, and playing back the subject's voice reading such text to the subject.

18. A therapeutic method of claim 16 wherein such text contains words, the speaking of which involves the making of one or more selected articulatory gestures.
